(19) United States
(12) Patent Application Publication
(10) Pub. No.: US 2007/0025448 A1
(43) Pub. Date: Feb. 1, 2007

(54) Deblocking filtering method considering intra-BL mode and multilayer video encoder/decoder using the same

(75) Inventors: Sang-chang Cha, Hwaseong-si (KR); Kyo-hyuk Lee, Seoul (KR); Bae-keun Lee, Bucheon-si (KR); Woo-jin Han, Suwon-si (KR); Jae-young Lee, Suwon-si (KR); Ho-jin Ha, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/483,646

(22) Filed: Jul. 11, 2006

Related U.S. Application Data
(60) Provisional application No. 60/703,505, filed on Jul. 29, 2005.

(30) Foreign Application Priority Data
Nov. 18, 2005 (KR) 10-2005-0110928

(51) Int. Cl. H04N 11/04; H04B 1/66

(52) U.S. Cl. 375/240.24; 375/240.29

(57) ABSTRACT

Deblocking filter used in a video encoder/decoder based on a multilayer. In deciding a deblocking filter strength when performing a deblocking filtering with respect to a boundary between a current block coded by an intra-BL mode and its neighboring block, it is determined whether the current block or the neighboring block has coefficients. The filter strength is decided as a first filter strength if it is determined that the current block or the neighboring block has the coefficients, and the filter strength is decided as a second filter strength if it is determined that the current block or the neighboring block does not have the coefficients. The first filter strength is greater than the second filter strength.

### CROSS-REFERENCE TO RELATED APPLICATIONS

This application claims priority from Korean Patent Application No. 10-2005-0110928 filed on Nov. 18, 2005 in the Korean Intellectual Property Office, and U.S. Provisional Patent Application No. 60/703,505 filed on Jul. 29, 2005 in the United States Patent and Trademark Office, the disclosures of which are incorporated herein by reference in their entirety.

### BACKGROUND OF THE INVENTION

1. Field of the Invention

Methods and apparatuses consistent with the present invention relate to video compression technology, and more particularly, to a deblocking filter used in a multilayer video encoder/decoder.

2. Description of the Related Art

With the development of information and communication technologies, multimedia communications are increasing in addition to text and voice communications. Existing text-centered communication systems are insufficient to satisfy consumers' diverse desires, and thus multimedia services that can accommodate diverse forms of information such as text, image, music, and others, are increasing. Since multimedia data is large, mass storage media and wide bandwidths are respectively required for storing and transmitting it. Accordingly, compression coding techniques are required to transmit the multimedia data.

The basic principle of data compression is to remove redundancy. Data can be compressed by removing spatial redundancy such as a repetition of the same color or object in images, temporal redundancy such as similar neighboring frames in moving images or continuous repetition of sounds and visual/perceptual redundancy, which considers human insensitivity to high frequencies. In a general video coding method, temporal redundancy is removed by temporal filtering based on motion compensation, and spatial redundancy is removed by a spatial transform.

In order to transmit multimedia, transmission media are required, the performances of which differ. Presently used transmission media have various transmission speeds. For example, an ultrahigh-speed communication network can transmit several tens of megabits of data per second and a mobile communication network has a transmission speed of 384 kilobits per second. In order to support the transmission media in such a transmission environment, and to transmit multimedia with a transmission rate suitable for the transmission environment, a scalable data coding method is most suitable.

This coding method makes it possible to perform a partial decoding of one compressed bitstream at a decoder or pre-decoder end according to the bit rate, error rate, and system resource conditions. The decoder or pre-decoder can restore a multimedia sequence having a differing picture quality, resolution or frame rate by adopting only a part of the bitstream coded by the scalable coding method.

With respect to such scalable video coding, Moving Picture Experts Group-21 (MPEG-21) PART-13 has already progressed its standardization work. Particularly, much research for implementing scalability in a video coding method based on a multilayer has been done. As an example of such multilayered video coding, a multilayer structure is composed of a base layer, a first enhancement layer and a second enhancement layer, and the respective layers have different resolutions such as Quarter Common Intermediate Format (QCIF), Common Intermediate Format (CIF) and 2CIF, and different frame rates.

FIG. 1 illustrates an example of a scalable video codec using a multilayer structure. In this video codec, the base layer is set to QCIF at 15 Hz (frame rate), the first enhancement layer is set to CIF at 30 Hz, and the second enhancement layer is set to Standard Definition (SD) at 60 Hz.

In encoding such a multilayered video frame, the correlation among the layers may be used. For example, a certain area 12 of the video frame of the first enhancement layer is efficiently encoded through prediction from the corresponding area 13 of the video frame of the base layer. In the same manner, an area 11 of the video frame of the second enhancement layer can be efficiently encoded through prediction from the area 12 of the first enhancement layer. If the respective layers of the multilayered video frame have different resolutions, the image of the base layer should be upsampled before the prediction is performed.

In the current scalable video coding standard (hereinafter referred to as the SVC standard) that was produced by Joint Video Team (JVT), which is a video experts group of the International Organization for Standardization/International Electrotechnical Commission (ISO/IEC) and International Telecommunication Union (ITU), research is under way for implementing the multilayered video codec as in the example illustrated in FIG. 1 based on the existing H.264 standard.

However, H.264 uses a discrete cosine transform (DCT) as a spatial transform method, and in a DCT-based codec undesirable blocking artifacts occur as the compression rate is increased. There are two causes of the blocking artifacts.

The first cause is the block-based integer DCT transform. This is because discontinuity occurs at a block boundary due to the quantization of DCT coefficients resulting from the DCT transform. Since H.264 uses a 4×4 size DCT transform, which is relatively small, the discontinuity problem may be somewhat reduced, but it cannot be totally eliminated.

The second cause is the motion compensation prediction. A motion-compensated block is generated by copying pixel data interpolated from another position of a different reference frame. Since these sets of data do not accurately coincide with each other, a discontinuity occurs at the edge of the copied block. Also, during the copying process, this discontinuity is transferred to the motion-compensated block.

Recently, several technologies for solving the blocking artifacts have been developed. In order to reduce the blocking effect, H.264 and MPEG-4 have proposed an overlapped block motion compensation (OBMC) technique. Even though the OBMC is effective at reducing the blocking artifacts, it has the problem that it requires a great amount of computation for the motion prediction, which is performed at the encoder end. Accordingly, H.264 uses a deblocking filter in order to reduce the blocking artifacts and to improve the picture quality. The blocking filter process is performed at the encoder or decoder end before the macroblock is restored and after the inverse transform thereof is performed. In this case, the strength of the deblocking filter can be adjusted to suit various conditions.

FIG. 2 is a flowchart explaining a method of deciding the deblocking filter strength according to the conventional H.264 standard. Here, block q and block p are two blocks that define a block boundary to which the deblocking filter will be applied, and represent a current block and a neighboring block. Five types of filter strengths (indicated as Bs=0 to 4) are set depending on whether the block p or q is an intra-coded block, whether a target sample is located at a macro-block boundary, whether the block p or q is coded-block, and others. If Bs=0, it means that the deblocking filter is not applied to the corresponding target pixel.

In other words, according to the conventional method to decide the deblocking filter strength, the filter strength is based on whether the current block, in which the target sample exists, and the neighboring block are intra-coded, inter-coded, or uncoded. The filter strength is also based on whether the target sample exists at the boundary of a 4×4 block or at the boundary of a 16×16 block.

In the presently proceeding SVC standard draft, in addition to an existing inter-coding method (i.e., the inter-mode) and an intra-coding method (i.e., the intra-mode), an intra-BL coding method (i.e., intra-BL mode), which is a method of predicting a frame on the current layer by using a frame created on a lower layer, has been adopted, as shown in FIG. 3.

FIG. 3 is a view schematically explaining the above-described three coding modes. First (\textcircled{1}) intra-coding of a certain macroblock 4 of the current frame 1 is performed, second (\textcircled{2}) inter-coding using a frame 2 that is at a temporal position different from that of the current frame 1 is performed, and third (\textcircled{3}) intra-BL coding using an image of an area 6 of a base layer frame 3 that corresponds to the macroblock 4 is performed.

As described above, in the scalable video coding standard, one advantageous method is selected among the three prediction methods in the unit of a macroblock, and the corresponding macroblock is encoded accordingly. That is, one of the inter-prediction method, the intra-prediction method, and the intra-BL prediction method is selectively used for one macroblock.

In the current SVC standard, the deblocking filter strength is decided to follow the conventional H.264 standard as it is, as shown in FIG. 2.

However, since the deblocking filter is applied to layers in the multilayer video encoder/decoder, it is unreasonable to strongly apply the deblocking filter again to the frame provided from the lower layer in order to efficiently predict the current layer frame. Nevertheless, since, in the current SVC standard, the intra-BL mode is considered as a type of intra-coding and the method of deciding the filter strength according to H.264, as illustrated in FIG. 2, is applied as it is, and no consideration is given to whether the current block has been coded in the intra-BL mode when deciding the filter strength.

It is known that the picture quality of the restored video is greatly improved when the filter strength is suitable to the respective conditions and the deblocking filter is applied at a suitable filter strength. Accordingly, it is necessary to research techniques that properly decide the filter strength in consideration of the intra-BL mode during the multilayered video encoding/decoding operation.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

The present invention provides a proper deblocking filter strength according to whether a certain block to which the deblocking filter will be applied uses an intra-BL mode in a video encoder/decoder based on a multilayer.

According to an aspect of the present invention, there is provided a method of deciding a deblocking filter strength when performing a deblocking filtering with respect to a boundary between a current block coded by an intra-BL mode and its neighboring block, according to the present invention, which includes determining whether the current block or the neighboring block has coefficients; deciding the filter strength as a first filter strength if the current block or the neighboring block has the coefficients as a result of the judgment; and deciding the filter strength as a second filter strength if the current block or the neighboring block does not have the coefficients as a result of the judgment; wherein the first filter strength is higher than the second filter strength.

According to another aspect of the present invention, there is provided a method of deciding a deblocking filter strength when performing a deblocking filtering with respect to a boundary between a current block coded by an intra-BL mode and its neighboring block, which includes determining whether the current block or the neighboring block corresponds to the intra-BL mode in which the current block and the neighboring block have the same base frame; deciding the filter strength as a first filter strength if the current block or the neighboring block does not correspond to the intra-BL mode as a result of the judgment; and deciding the filter strength as a second filter strength if the current block or the neighboring block corresponds to the intra-BL mode as a result of the judgment; wherein the first filter strength is higher than the second filter strength.

According to still another aspect of the present invention, there is provided a method of deciding a deblocking filter strength when performing a deblocking filtering with respect to a boundary between a current block coded by an intra-BL mode and its neighboring block, which includes determining whether the current block and the neighboring block have coefficients; determining whether the current block and the neighboring block correspond to the intra-BL mode in which the current block and the neighboring block have the same base frame; and on the assumption that a first condition is that the current block and the neighboring block have the coefficients and a second condition is that the current block and the neighboring block do not correspond to the intra-BL mode in which the current block and the neighboring block have the same base frame, deciding the filter strength as a first filter strength if both the first and second conditions are satisfied, deciding the filter strength as a second filter strength if either of the first and second conditions is satisfied, and deciding the filter strength as a third filter strength if neither of the first and second conditions is satisfied; wherein the filter strength is gradually lowered in the order of the first filter strength, the second filter strength, and the third filter strength.

According to still another aspect of the present invention, there is provided a video encoding method based on a multilayer using a deblocking filtering, which includes encoding an input video frame; decoding the encoded frame; deciding a deblocking filter strength to be applied with respect to a boundary between a current block and its neighboring block that are included in the decoded frame; and performing the deblocking filtering with respect to the boundary according to the decided deblocking filter strength; wherein the deciding the deblocking filter strength is performed considering whether the current block corresponds to an intra-BL mode and whether the current block or the neighboring block has coefficients.

According to still another aspect of the present invention, there is provided a video decoding method based on a multilayer using a deblocking filtering, which includes restoring a video frame from an input bitstream; deciding a deblocking filter strength to be applied with respect to a boundary between a current block and its neighboring block that are included in the restored frame; and performing the deblocking filtering with respect to the boundary according to the decided deblocking filter strength; wherein the deciding the deblocking filter strength is performed considering whether the current block corresponds to an intra-BL mode and whether the current block or the neighboring block has coefficients.

According to still another aspect of the present invention, there is provided a video encoder based on a multilayer using deblocking filtering, which includes a first unit encoding an input video frame; a second unit decoding the encoded frame; a third unit deciding a deblocking filter strength to be applied with respect to a boundary between a current block and its neighboring block that are included in the decoded frame; and a fourth unit performing the deblocking filtering with respect to the boundary according to the decided deblocking filter strength; wherein the third unit decides the filter strength considering whether the current block corresponds to an intra-BL mode and whether the current block or the neighboring block has coefficients.

According to still another aspect of the present invention, there is provided a video decoding method based on a multilayer using a deblocking filtering, which includes a first unit restoring a video frame from an input bitstream; a second unit deciding a deblocking filter strength to be applied with respect to a boundary between a current block and its neighboring block that are included in the restored frame; and a third unit performing the deblocking filtering with respect to the boundary according to the decided deblocking filter strength; wherein the second unit decides the filter strength considering whether the current block corresponds to an intra-BL mode and whether the current block or the neighboring block has coefficients.

### BRIEF DESCRIPTION OF THE DRAWINGS

The above and other aspects of the present invention will be more apparent from the following detailed description of exemplary embodiments taken in conjunction with the accompanying drawings, in which:

FIG. 1 is a view illustrating an example of a scalable video codec using a multilayer structure;

FIG. 2 is a flowchart illustrating a method of deciding a deblocking filter strength according to the conventional H.264 standard;

FIG. 3 is a schematic view explaining three scalable video coding methods;

FIG. 4 is a view illustrating an example of an intra-BL mode based on the same base frame;

FIG. 5 is a flowchart illustrating a method of deciding the filter strength of a multilayer video coder according to an exemplary embodiment of the present invention;

FIG. 6 is a view illustrating a vertical boundary and target samples of a block;

FIG. 7 is a view illustrating a horizontal boundary and target samples of a block;

FIG. 8 is a view illustrating the positional correlation of the current block q with its neighboring blocks Pa and Pb;

FIG. 9 is a block diagram illustrating the construction of an open loop type video encoder according to an exemplary embodiment of the present invention;

FIG. 10 is a view illustrating the structure of a bitstream generated according to an exemplary embodiment of the present invention;

FIG. 11 is a view illustrating boundaries of a macroblock and blocks with respect to a luminance component;

FIG. 12 is a view illustrating boundaries of a macroblock and blocks with respect to a chrominance component; and

FIG. 13 is a block diagram illustrating the construction of a video encoder according to an exemplary embodiment of the present invention.

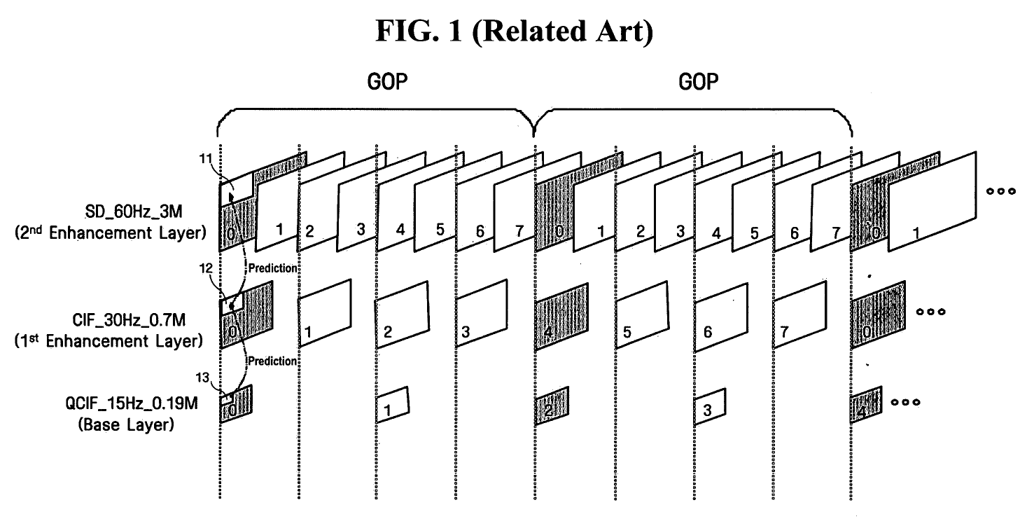

### DETAILED DESCRIPTION OF THE EXEMPLARY EMBODIMENTS

Hereinafter, exemplary embodiments of the present invention will be described in detail with reference to the accompanying drawings. The aspects and features of the present invention and methods for achieving the aspects and features will be apparent by referring to the exemplary embodiments to be described in detail with reference to the accompanying drawings. However, the present invention is not limited to the exemplary embodiments disclosed hereinafter, but can be implemented in diverse forms. The matters defined in the description, such as the detailed construction and elements, are provided to assist those of ordinary skill in the art in a comprehensive understanding of the invention, and the present invention is only defined within the scope of the appended claims. In the entire description of the present invention, the same drawing reference numerals are used for the same elements across various figures.

In the present invention, a conventional H.264 directional intra-prediction mode (hereinafter referred to as “directional intra-mode”) and an intra-BL mode that refers to frames of another layer are strictly discriminated from each other, and the intra-BL mode is determined as a type of inter-prediction mode (hereinafter referred to as “inter-mode”). This is because the inter-mode refers to neighboring frames in the same layer when predicting the current frame, and it is similar to the inter-BL mode that refers to frames of another layer, i.e., base frames, in predicting the current frame. That is, the only difference between the inter-mode and the intra-BL mode is which frame is referred to during the prediction.

In the following description, in order to clearly discriminate between the H.264 intra-mode and the intra-BL mode, the intra-mode will be defined as a directional intra-mode.

In the present invention, the conventional H.264 filter strength is applied if the current block q does not correspond to an intra-BL mode, while a new algorithm for selecting a filter strength is applied if the current block corresponds to the intra-BL mode. According to this algorithm, a maximum filter strength (Bs=4) is applied in the case where the current block q and the neighboring block p correspond to the intra-mode. Otherwise, the current block q may correspond to the intra-BL mode or the inter-mode, and in this case, a first condition that the current block q or the neighboring block p has a coefficient, and a second condition that the current block q and the neighboring block p do not correspond to the intra-BL mode, in which the blocks p and q have the same base frame, are set.

The first condition considers that a relatively high filter strength must be used in the case where at least one of the current block q and the neighboring block p has the coefficient. Generally, if a certain value, which is to be coded during the video coding, is smaller than a threshold value, it is simply changed to “0”, but it is not coded. Accordingly, the coefficient included in the block becomes “0”, and the corresponding block may have no coefficient. With respect to a block having no coefficient, a high-strength filter must be applied.

The second condition considers that the current block q and the neighboring block p do not correspond to the intra-BL mode in which the blocks p and q have the same base frame. Accordingly, in the case where the current block q or the neighboring block p corresponds to the inter-mode, or the current block q and the neighboring block p corresponds to the intra-BL mode in which the blocks p and q have different base frames, the second condition is not satisfied.

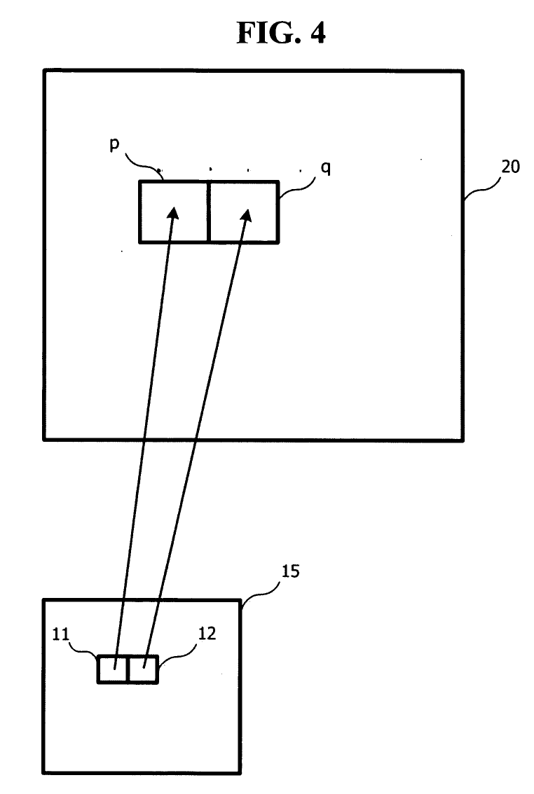

As illustrated in FIG. 4, it is assumed that two blocks p and q that correspond to the intra-BL mode have the same base frame 15. The two blocks p and q belong to the current frame 20, and are coded with reference to corresponding areas 11 and 12 in the base frame 15. As described above, in the case of taking reference images from the same base frame, there is a low possibility that block artifacts occur at the boundary between the two blocks. However, if the reference images are taken from different base frames, there would be a high possibility that the block artifacts occur. In the inter-mode, although the two blocks p and q refer to the same frame, there is a great possibility that the reference images do not neighbor each other, unlike the two blocks p and q, and this causes a high possibility of block artifact occurrence. Consequently, in the case where the second condition is satisfied, a relatively high filter strength should be applied, in comparison to the case where the second condition is not satisfied.

In the exemplary embodiment of the present invention, the filter strength is set to “2” if both the first condition and the second condition are satisfied, set to “1” if either of the first and second conditions is satisfied, and set to “0” if neither of the first and second conditions is satisfied, respectively. Although the detailed filter strength values (“0”, “1”, “2”, and “4”) are merely exemplary, the order of the filter strengths should be maintained as it is.

On the other hand, it is not necessary to simultaneously determine the first condition and the second condition. The filter strength may be decided by determining the first condition only. In this case, the filter strength that satisfies the first condition should be at least higher than the filter strength that does not satisfy the first condition. In the same manner, the filter strength may be decided by determining the second condition only. In this case, the filter strength that satisfies the second condition should be at least higher than the filter strength that does not satisfy the second condition.

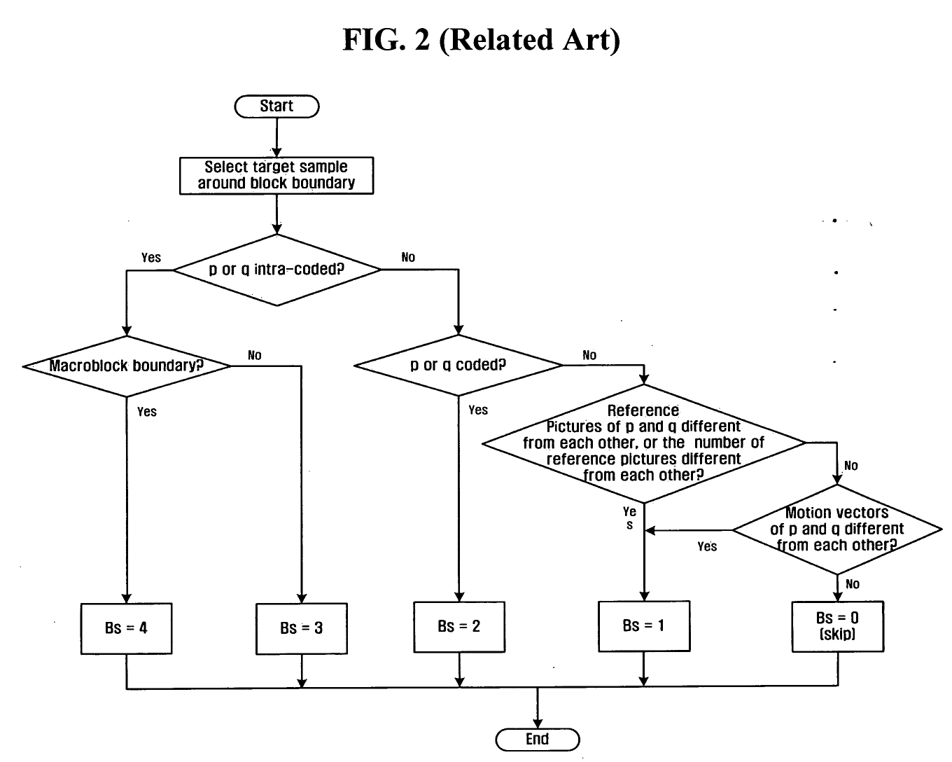

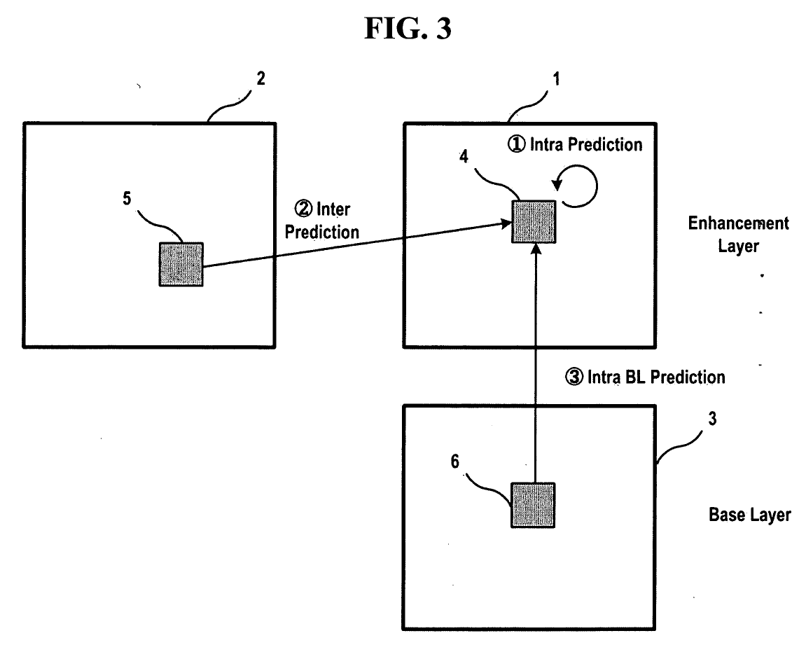

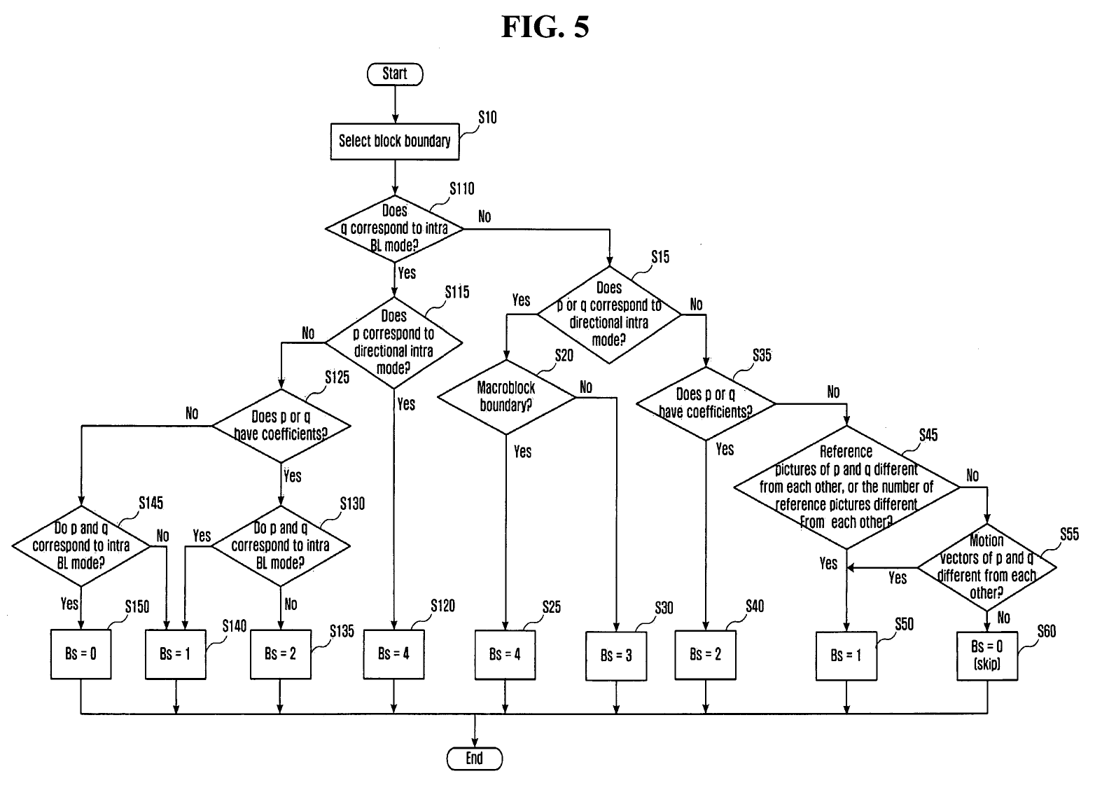

FIG. 5 is a flowchart illustrating a method of deciding the filter strength of a multilayer video coder according to an exemplary embodiment of the present invention. In the following description, the term “video coder” is used as the common designation of a video encoder and a video decoder. The exemplary embodiment of the present invention, as illustrated in FIG. 4, additionally includes operations S110, S115, S125, S130 and S145 in comparison to the conventional method, as illustrated in FIG. 2.

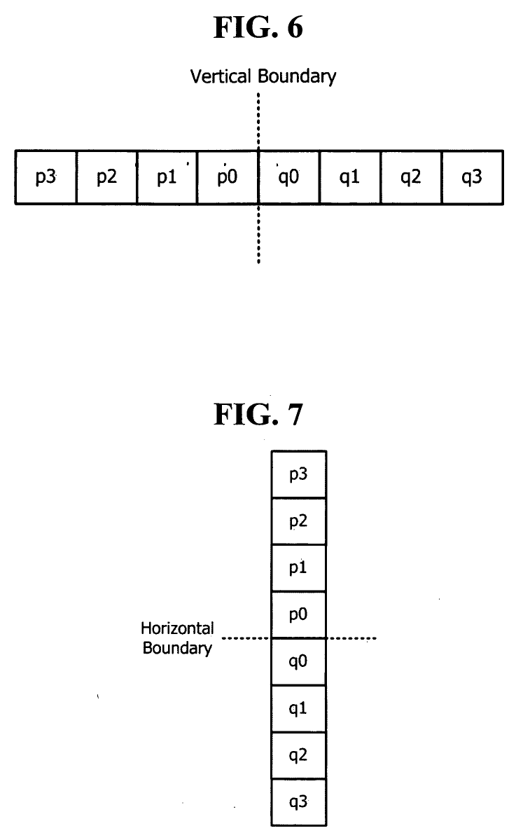

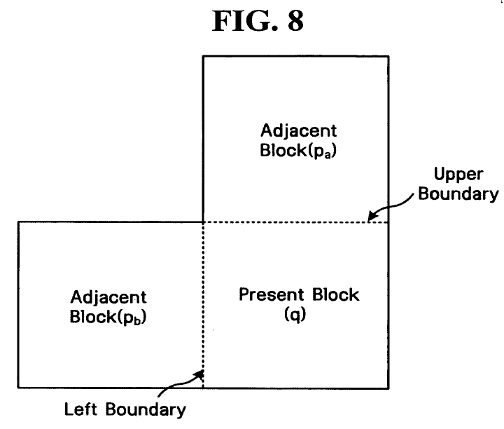

First, a boundary of neighboring blocks (e.g., 4×4 pixel blocks), to which a deblocking filter is to be applied, is selected (S10). The deblocking filter is to be applied to a block boundary part, and in particular, target samples that neighbor the block boundary. The target samples mean a set of samples arranged as shown in FIG. 6 or FIG. 7 around the boundary between a current block q and its neighboring block p. As shown in FIG. 8, with consideration to the order of block generation, the upper block and the left block of the current block q correspond to the neighboring blocks P (Pa and Pb), and thus the targets to which the deblocking filter is applied are the upper boundary and the left boundary of the current block q. The lower boundary and the right boundary of the current block q are filtered during the next deblocking process for the lower block and the right block of the current block.

In the exemplary embodiment of the present invention, each block has a 4×4 pixel size, considering that according to the H.264 standard, the minimum size of a variable block in motion prediction is 4×4 pixels. However, it will be apparent to those skilled in the art that the filtering can also be applied to the block boundaries of 8×8 blocks and other block sizes.

Referring to FIG. 6, target samples appear around the left boundary of the current block q in the case where the block boundary is vertical. The target samples include four samples p0, p1, p2 and p3 on the left side of the vertical boundary line, which exist in the neighboring block p, and four samples q0, q1, q2 and q3 on the right side of the boundary line, which exist in the current block q. Although a total of four samples are subject to filtering, the number of reference samples and the number of filtered samples may be changed according to the decided filter strength.

Referring to FIG. 7, target samples appear around the upper boundary of the current block q in the case in where the block boundary is horizontal. The target samples include four samples p0, p1, p2 and p3 existing in the upper half of the horizontal boundary line (neighboring block p), and four samples q0, q1, q2 and q3 existing in the lower half of the horizontal boundary line (current block q).

According to the existing H.264 standard, the deblocking filter is applied to the luminance signal component and the chrominance signal component, respectively, and the filtering is successively performed in a raster scan order on a unit of a macroblock that constitutes one frame. With respect to the respective macroblocks, the filtering in the horizontal direction (as shown in FIG. 7) may be performed after the filtering in the vertical direction (as shown in FIG. 6) is performed, and vice versa.

Referring again to FIG. 5, after operation S10, it is determined whether the current block q corresponds to an intra-BL mode (S110). If the current block does not correspond to the intra-BL mode as a result of judgment (“No” in operation S110), the conventional H.264 filter strength deciding algorithm is subsequently performed.

Specifically, it is determined whether at least one of block p and block q, to which the target samples belong, corresponds to a directional intra-mode (S15). If at least one of block p and block q corresponds to the directional intra-mode (“Yes” in operation S15), it is determined whether the block boundary is included in the macroblock boundary (S20). If so, the filter strength Bs is set to “4” (S25); if not, Bs is set to “3” (S30). The judgment in operation S20 is performed in consideration of the fact that the possibility of the block artifact occurrence is heightened in the macroblock boundary, in comparison to other block boundaries.

If neither of block p and block q corresponds to the directional intra-mode (“No” in operation S15), it is determined whether block p or block q has the coefficients (S35). If at least one of block p and block q is coded (“Yes” in operation S35), Bs is set to “2” (S40). However, if the reference frames of block p and block q are different or the numbers of the reference frames are different (“Yes” in operation S45) in a state where neither of the blocks has been coded (“No” in operation S35), Bs is set to “1” (S50). This is because the fact that the blocks p and q have different reference frames means that the possibility that the block artifacts have occurred is relatively high.

If the reference frames of the blocks p and q are not different, or the numbers of the reference frames between them are not different (“No” in operation S45), as a result of judgment in operation S45, it is determined whether motion vectors of block p and block q are different (S55). This is because since in the case in which the motion vectors do not coincide with each other, although both blocks have the same reference frames (“No” in operation S45), the possibility that the block artifacts have occurred is relatively high in comparison to the case in which the motion vectors coincide with each other. If the motion vectors of block p and block q are different in operation S55 (“Yes” in operation S55), Bs is set to “1” (S50); if not, Bs is set to “0” (S60).

On the other hand, if block q corresponds to the intra-BL mode as a result of judgment in operation S110 (“Yes” in operation S110), the filter strength is decided using the first condition and the second condition which are proposed according to the present invention.

Specifically, it is first determined whether the neighboring block p corresponds to the directional intra-mode (S115). If the block p corresponds to the directional intra-mode, Bs is set to “4” (S120). This is because the intra coding that uses the intra-frame similarity greatly heightens the block artifacts in comparison to the inter coding that uses the inter-frame similarity. Accordingly, the filter strength is relatively heightened if the intra-coded block exists in comparison to the case that the intra-coded block does not exist.

If the block p does not corresponds to the directional intra-mode (“No” in operation S115), it is determined whether the first condition and the second condition are satisfied. First, it is determined whether the first condition is satisfied, i.e., whether p or q has the coefficients, (S125), and if so, it is determined whether p and q correspond to the intra-BL mode in which p and q have the same base frame (S130). If p and q correspond to the intra-BL mode (“Yes” in operation S130), i.e., if the second condition is not satisfied, Bs is set to “1” (S140); if the second condition is satisfied, Bs is set to “2” (S135).

If both p and q have no coefficient as a result of judgment in operation S125 (“No” in operation S125), it is determined whether p and q correspond to the intra-BL mode in which P and q have the same base frame in the same manner (S145). If so (“Yes” in operation S145), i.e., if the second condition is not satisfied, Bs is set to “0”. If not (“No” in operation S145), i.e., if the second condition is satisfied, Bs is set to “1”.

As described above, in operations S120, S135, S140, and S150, the respective filter strengths Bs have been set to “4”, “2”, “1”, and “0”. However, this is merely exemplary, and they may be set to other values as long as their strength order is maintained, without departing from the scope of the present invention.

In the case where the current block q corresponds to the intra-BL mode (“Yes” in operation S110), unlike the case where it does not correspond to the intra-BL mode (“No” in operation S110), the operation S20 of determining whether the block boundary is the macroblock boundary is not included. This is because it can be confirmed it cannot greatly affect the change of filter strength whether the block boundary belongs to the macroblock boundary, in the case where the current block corresponds to the intra-BL mode.

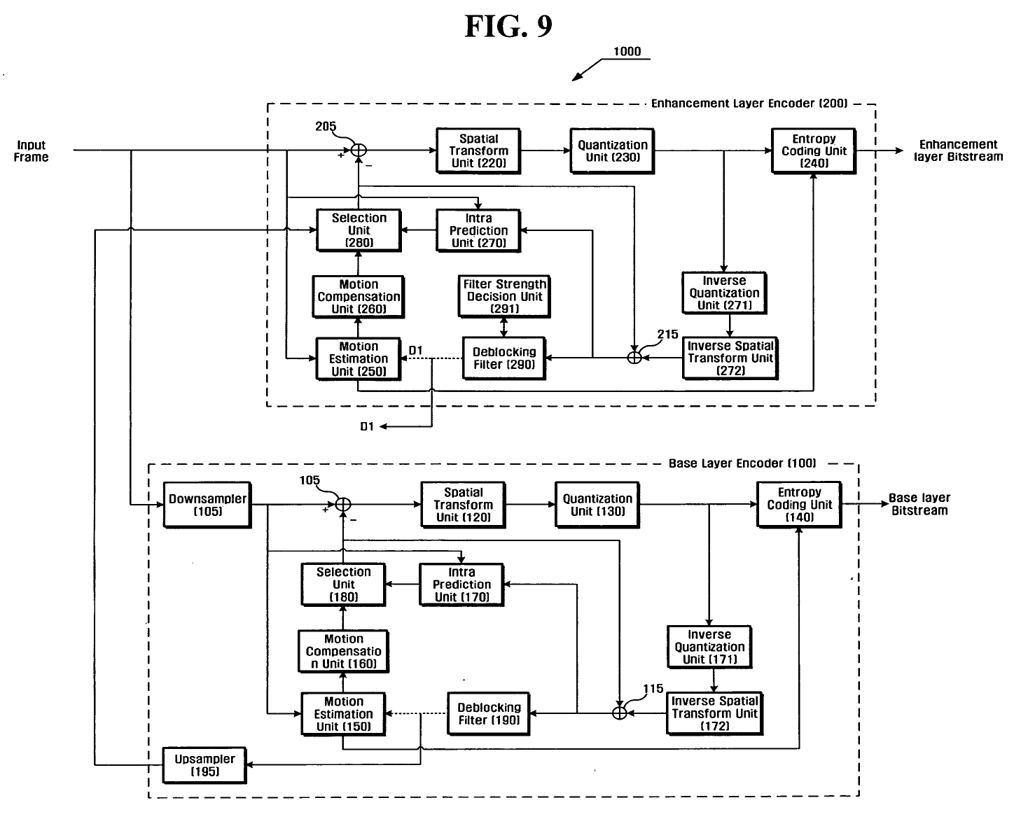

FIG. 9 is a block diagram illustrating the construction of a multilayer video encoder that includes a deblocking filter using the method of deciding the filter strength as shown in FIG. 5. The multilayer video encoder may be implemented as a closed-loop type or an open-loop type. Here, the closed-loop type video encoder performs a prediction with reference to the original frame, and the open-loop type video encoder performs a prediction with reference to a restored frame.

A selection unit 280 selects and outputs one of a signal transferred from an upsampler 195 of a base layer encoder 100, a signal transferred from a motion compensation unit 260 and a signal transferred from an intra-prediction unit 270. This selection is performed by selecting from an intra-BL mode, an inter-prediction mode and an intra-prediction mode, that has the highest coding efficiency.

An intra-prediction unit 270 predicts an image of the current block from an image of a restored neighboring block provided from an adder 215 according to a specified intra-prediction mode. H.264 defines such an intra-prediction mode, which includes eight modes having directions and one DC mode. Selection of one mode among them is performed by selecting the mode that has the highest coding efficiency. The intra-prediction unit 270 provides predicted blocks generated according to the selected intra-prediction mode to an adder 205.

A motion estimation unit 250 performs motion estimation on the current macroblock of input video frames based on the reference frame and obtains motion vectors. An algorithm that is widely used for the motion estimation is a block matching algorithm. This block matching algorithm estimates a displacement that corresponds to the minimum error as a motion vector in a specified search area of the reference frame. The motion estimation may be performed using a motion block of a fixed size or using a motion block having a variable size according to the hierarchical variable size block matching (HVSBM) algorithm. The motion estimation unit 250 provides motion data such as the motion vectors obtained as a result of motion estimation, the mode of the motion block, the reference frame number, and others, to an entropy coding unit 240.

A motion compensation unit 260 performs motion compensation using the motion vector calculated by the motion estimation unit 250 and the reference frame and generates an inter-predicted image for the current frame.

A subtracter 205 generates a residual frame by subtracting a signal selected by the selection unit 280 from the current input frame signal.

A spatial transform unit 220 performs a spatial transform of the residual frame generated by the subtracter 205. DCT, wavelet transform, and others may be used as the spatial transform method. Transform coefficients are obtained as a result of spatial transform. In the case of using the DCT as the spatial transform method, DCT coefficients are obtained, and in the case of using the wavelet transform method, wavelet coefficients are obtained.

A quantization unit 230 generates quantization coefficients by quantizing the transform coefficients obtained by the spatial transform unit 220. The quantization means representing the transform coefficients expressed as real values by discrete values by dividing the transform values at predetermined intervals. Such a quantization method may be a scalar quantization, vector quantization, or others, and the scalar quantization method is performed by dividing the transform coefficients by corresponding values from a quantization table and rounding the resultant values off to the nearest whole number.

In the case of using the wavelet transform as the spatial transform method, an embedded quantization method is mainly used as the quantization method. This embedded quantization method performs an efficient quantization using the spatial redundancy by preferentially coding components of the transform coefficients that exceed a threshold value by changing the threshold value (to ½). The embedded quantization method may be the Embedded Zerotrees Wavelet Algorithm (EZW), Set Partitioning in Hierarchical Trees (SPIHT), or Embedded ZeroBlock Coding (EZBC).

The coding process before the entropy coding as described above is called lossy coding.

The entropy coding unit 240 performs a lossless coding of the quantization coefficients and motion information provided by the motion estimation unit 250 and generates an output bitstream. Arithmetic coding or variable length coding may be used as the lossless coding method.

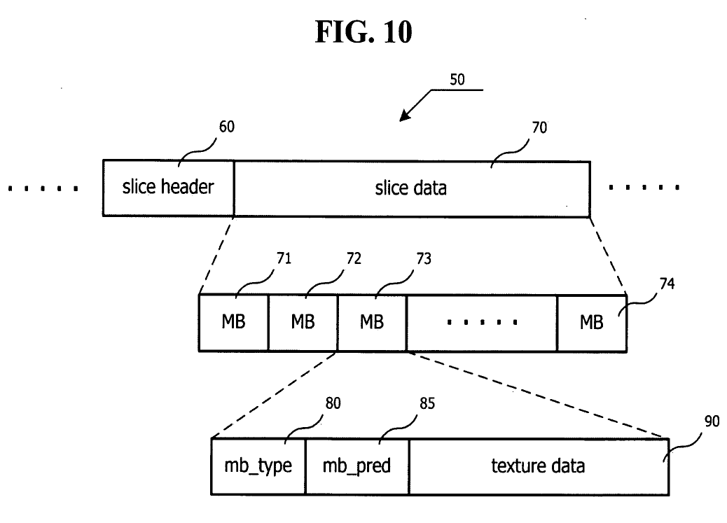

FIG. 10 is a view illustrating an example of the structure of a bitstream 50 generated according to an exemplary embodiment of the present invention. In H.264, the bitstream is coded in the unit of a slice. The bitstream 50 includes a slice header 60 and slice data 70, and the slice data 70 is composed of a plurality of macroblocks (MBs) 71 to 74. A macroblock data 73 is composed of an mb_type field 80, an mb_pred field 85 and a texture data field 90.

In the mb_type field 80, a value that indicates the type of the macroblock is recorded. That is, this field indicates whether the current macroblock is an intra macroblock, inter macroblock or intra-BL macroblock.

In the mb_pred field 85, a detailed prediction mode according to the type of the macroblock is recorded. In the case of the intra macroblock, the selected intra-prediction mode is recorded, and in the case of the inter macroblock, a reference frame number and a motion vector by macroblock partitions are recorded.

In the texture data field 90, the coded residual frame, i.e., texture data, is recorded.

Referring again to FIG. 9, an enhanced-layer encoder 200 further includes an inverse quantization unit 271, an inverse DCT transform unit 272 and an adder 215, which are used to restore the lossy-coded frame by inversely decoding it.

The inverse quantization unit 271 inversely quantizes the coefficients quantized by the quantization unit 230. This inverse quantization process is the inverse process of the quantization process. The inverse spatial transform unit 272 performs an inverse transform of the quantized results and provides the inversely-transformed results to the adder 215.

The adder 215 restores the video frame by adding a signal provided from the inverse spatial transform unit 272 to a predicted signal selected by the selection unit 280 and stored in a frame buffer (not illustrated). The video frame restored by the adder 215 is provided to a deblocking filter 290, and the image of the neighboring block of the restored video frame is provided to the intra-prediction unit 270.

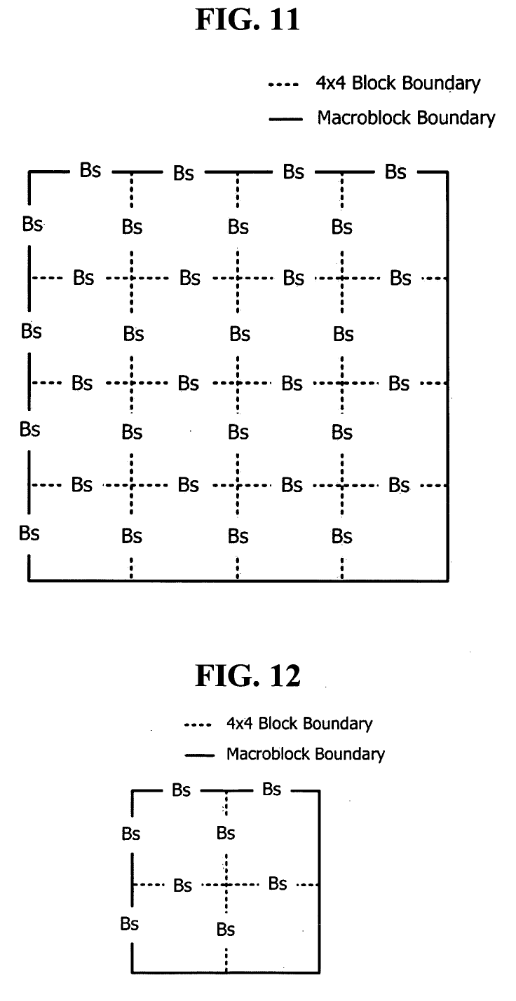

A filter strength decision unit 291 decides the filter strength with respect to the macroblock boundary and the block (for example, a 4×4 block) boundaries in one macroblock according to the filter strength decision method as explained with reference to FIG. 5. In the case of a luminance component, the macroblock has a size of 16×16 pixels, as illustrated in FIG. 11, and in the case of a chrominance component, the macroblock has a size of 8×8 pixels, as illustrated in FIG. 12. In FIGS. 11 and 12, “Bs” is marked on the boundary on which the filter strength is to be indicated in one macroblock. However, “Bs” is not marked on the right boundary line and the lower boundary line of the macroblock. If no macroblock exists to the right or below the current macroblock, the deblocking filter for the corresponding part is unnecessary, while if a macroblock exists to the right or below the current macroblock, the filter strength of the boundary lines is decided during the deblocking filtering process of the corresponding macroblock.

The deblocking filter 290 actually performs the deblocking filtering with respect to the respective boundary lines according to the filter strength decided by the filter strength decision unit 291. Referring to FIGS. 6 and 7, on both sides of the vertical boundary or the horizontal boundary, four pixels are indicated. The filtering operation can affect three pixels on each side of the boundary, i.e., {p2, p1, p0, q0, q1, q2}, at maximum. This is decided with consideration to the filter strength Bs, quantization parameter QP of the neighboring block, and others.

However, in the deblocking filtering, it is very important to discriminate the real edge existing in the frame from the edge generated by quantizing the DCT coefficients. In order to keep the distinction of the image, the real edge should remain without being filtered as much as possible, but the artificial edge should be filtered to be imperceptible. Accordingly, the filtering is performed only when all conditions of Equation (1) are satisfied.
Bs≠0, |p0−q0|<α, |p1−p0|<β, q1−q0|<β (1)

Here, α and β are threshold values determined according to the quantization parameter, FilterOffsetA, FilterOffsetB, and others.

If Bs is “1”, “2” or “3” and a 4-tab filter is applied to inputs p1, p0, q0 and q1, filtered outputs will be P0 (which is the result of filtering p0) and Q0 (which is the result of filtering q0). With regards to the luminance component, if |p2−p0|<β, the 4-tab filter is applied to the inputs p2, p1, p1 and q0, and the filtered output is P1 (which is the result of filtering p1). In the same manner, if |q2−q0|<β, the 4-tab filter is applied to the inputs q2, q1, q0 and p0, and the filtered output is Q1 (which is the result of filtering q1).

On the other hand, if Bs is “4”, a 3-tab filter, a 4-tab filter or a 5-tab filter is applied to the inputs and P0, P1 and P2 (which are the results of filtering p2) and Q0, Q1 and Q2 (which are the results of filtering q2) can be outputted based on the threshold values α and β and eight actual pixels.

Referring again to FIG. 9, a resultant frame D1 filtered by the deblocking filter 290 is provided to the motion estimation unit 250 to be used for the inter-prediction of other input frames. Also, if an enhancement layer above the current enhancement layer exists, the frame D1 may be provided as a reference frame when the prediction of the intra-BL mode is performed on the upper enhancement layer.

However, the output D1 of the deblocking filter is inputted to the motion estimation unit 250 only in the case of the closed-loop type video encoder. In the case of the open-loop type video encoder such as a video encoder based on MCTF (Motion Compensated Temporal Filtering), the original frame is used as the reference frame during the inter prediction, and thus it is not required that the output of the deblocking filter be inputted to the motion estimation unit 250 again.

The base layer encoder 100 may include a spatial transform unit 120, a quantization unit 130, an entropy coding unit 140, a motion estimation unit 150, a motion compensation unit 160, an intra-prediction unit 170, a selection unit 180, an inverse quantization unit 171, an inverse spatial transform unit 172, a downsampler 105, an upsampler and a deblocking filter 190.

The downsampler 105 performs a down sampling of the original input frame to the resolution of the base layer, and the upsampler 195 performs an up sampling of the filtered output of the deblocking filter 190 and provides the upsampled result to the selection unit 280 of the enhancement layer.

Since the base layer encoder 100 cannot use information of a lower layer, the selection unit 180 selects one of the intra-predicted signal and the inter-predicted signal, and the deblocking filter 190 decides the filter strength in the same manner as in the conventional H.264.

Since operations of other constituent elements are the same as those of the constituent elements existing in the enhanced-layer encoder 200, the detailed explanation thereof will be omitted.

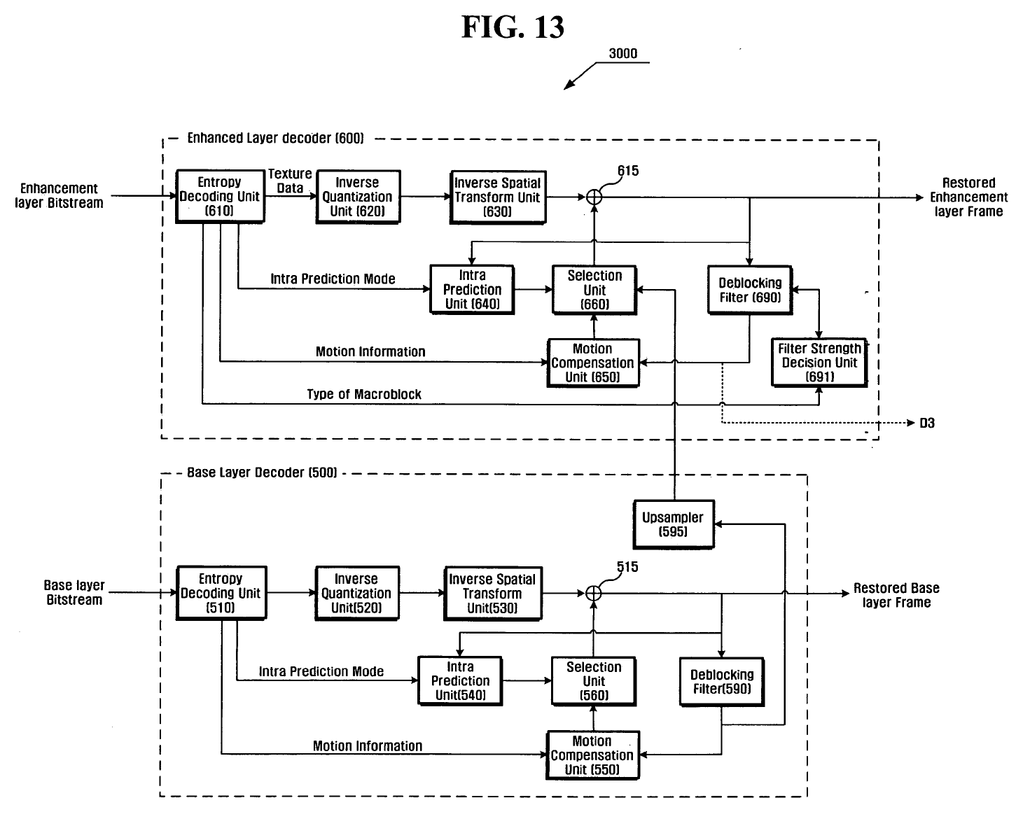

FIG. 13 is a block diagram illustrating the construction of a video decoder 3000 according to an exemplary embodiment of the present invention. The video decoder 3000 briefly includes an enhanced-layer decoder 600 and a base layer decoder 500.

First, the construction of the enhanced-layer decoder 600 will be explained. An entropy decoding unit 610 performs a lossless decoding of the input enhanced-layer bitstream, in contrast to the entropy coding unit, and extracts macroblock type information (i.e., information that indicates the type of the macroblock), intra-prediction mode, motion information, texture data, and others.

Here, the bitstream may be constructed as the example illustrated in FIG. 10. Here, the type of the macroblock is known from the mb_type field 80; the detailed intra-prediction mode and motion information is known from the mb_pred field 85; and the texture data is known by reading the texture data field 90.

The entropy decoding unit 610 provides the texture data to an inverse quantization unit 620, the intra-prediction mode to an intra-prediction unit 640 and motion information to a motion compensation unit 650. Also, the entropy decoding unit 610 provides the type of information of the current macroblock to a filter strength decision unit 691.

The inverse quantization unit 620 inversely quantizes the texture information transferred from the entropy decoding unit 610. At this time, the same quantization table as that used in the video encoder side is used.

Then, an inverse spatial transform unit 630 performs an inverse spatial transform on the result of inverse quantization. This inverse spatial transform corresponds to the spatial transform performed in the video encoder. That is, if the DCT transform is performed in the encoder, an inverse DCT is performed in the video decoder, and if the wavelet transform is performed in the video encoder, an inverse wavelet transform is performed in the video decoder. As a result of inverse spatial transform, the residual frame is restored.

The intra-prediction unit 640 generates a predicted block for the current intra block from the restored neighboring intra block outputted from an adder 615 according to the intra-prediction mode transferred from the entropy decoding unit 610 to provide the generated predicted block to the selection unit 660.

On the other hand, the motion compensation unit 650 performs motion compensation using the motion information provided from the entropy decoding unit 610 and the reference frame provided from a deblocking filter 690. The predicted frame, generated as a result of motion compensation, is provided to the selection unit 660.

Additionally, the selection unit 660 selects one among a signal transferred from an upsampler 590, a signal transferred from the motion compensation unit 650 and a signal transferred from the intra-prediction unit 640 and transfers the selected signal to the adder 615. At this time, the selection unit 660 discerns the type information of the current macroblock provided from the entropy decoding unit 610 and selects the corresponding signal among the three types of signals according to the type of the current macroblock.

The adder 615 adds the signal outputted from the inverse spatial transform unit 630 to the signal selected by the selection unit 660 to restore the video frame of the enhancement layer.

The filter strength decision unit 691 decides the filter strength with respect to the macroblock boundary and the block boundaries in one macroblock according to the filter strength decision method as explained with reference to FIG. 5. In this case, in order to perform the filtering, the type of the current macroblock, i.e., whether the current macroblock is an intra macroblock, inter macroblock, or intra-BL macroblock, should be known, and the information about the type of the macroblock, which is included in the header part of the bitstream, is transferred to the video decoder 3000.

The deblocking filter 690 performs a deblocking filtering of the respective boundary lines according to the filter strength decision unit 691. The resultant frame D3 filtered by the deblocking filter 690 is provided to the motion compensation unit 650 to generate an inter-prediction frame for other input frames. Also, if an enhancement layer above the current enhancement layer exists, the frame D3 may be provided as the reference frame when the prediction of the intra-BL mode is performed for the upper enhancement layer.

The construction of the base layer decoder 500 is similar to that of the enhanced-layer decoder. However, since the base layer decoder 500 cannot use information of a lower layer, a selection unit 560 selects one of the intra-predicted signal and the inter-predicted signal, and the deblocking filter 590 decides the filter strength in the same manner as in the conventional H.264 algorithm. Also, an upsampler 595 performs an up sampling of the result filtered by the deblocking filter 590 and provides the upsampled signal to the selection unit 660 of the enhancement layer.

Since operations of other constituent elements are the same as those of the constituent elements of the enhanced-layer decoder 600, a detailed explanation thereof will be omitted.

As described above, it is exemplified that the video encoder or the video decoder includes two layers, i.e., a base layer and an enhancement layer. However, this is merely exemplary, and it will be apparent to those skilled in the art that a video coder having three or more layers can be implemented.

Up to now, the respective constituent elements of FIG. 9 and FIG. 13 refer to software or hardware such as a Field Programmable Gate Array (FPGA) or an Application Specific Integrated Circuit (ASIC). However, the respective constituent elements may be constructed to reside in an addressable storage medium or to execute one or more processors. Functions provided in the respective constituent elements may be separated into further detailed constituent elements or combined into one constituent element, all of which perform specified functions.

According to the present invention, the deblocking filter strength can be properly set depending on whether a certain block, to which the deblocking filter will be applied, is an intra-BL mode block, in the multilayer video encoder/decoder.

Additionally, by setting the proper deblocking filter strength (as above), the picture quality of the restored video can be improved.

The exemplary embodiments of the present invention have been described for illustrative purposes, and those skilled in the art will appreciate that various modifications, additions and substitutions are possible without departing from the scope and spirit of the invention as disclosed in the accompanying claims. Therefore, the scope of the present invention should be defined by the appended claims and their legal equivalents.

What is claimed is:

1. A method of deciding a deblocking filter strength for performing a deblocking filtering with respect to a boundary between a current block coded by an intra-BL mode and a neighboring block, the method comprising:
(a) determining whether the current block or the neighboring block has coefficients;
(b) deciding the filter strength as a first filter strength if it is determined that the current block or the neighboring block has the coefficients; and
(c) deciding the filter strength as a second filter strength if it is determined that the current block or the neighboring block does not have the coefficients.

2. The method of claim 1, wherein the first filter strength is greater than the second filter strength.

3. The method of claim 2, further comprising:
determining whether the neighboring block corresponds to a directional intra-mode; and
deciding the filter strength as a third filter strength if it is determined that the neighboring block corresponds to the directional intra-mode,
wherein (a) through (c) are performed only if the neighboring block does not correspond to the directional intra-mode, and the third filter strength is greater than the first filter strength and the second filter strength.

4. The method of claim 3, wherein the boundary includes at least one of a horizontal boundary and a vertical boundary between the current block and the neighboring block.

5. The method of claim 4, wherein the first filter strength is “2”, the second filter strength is “0”, and the third filter strength is “4”.

6. A method of deciding a deblocking filter strength for performing a deblocking filtering with respect to a boundary between a current block coded by an intra-BL mode and a neighboring block, the method comprising:
(a) determining whether the current block or the neighboring block corresponds to the intra-BL mode in which the current block and the neighboring block have a same base frame;
(b) deciding the filter strength as a first filter strength if it is determined that the current block or the neighboring block does not correspond to the intra-BL mode; and
(c) deciding the filter strength as a second filter strength if it is determined that the current block or the neighboring block corresponds to the intra-BL mode.

7. The method of claim 6, wherein the first filter strength is greater than the second filter strength

8. The method of claim 7, further comprising:
determining whether the neighboring block corresponds to a directional intra-mode; and
deciding the filter strength as a third filter strength if it is determined that the neighboring block corresponds to the directional intra-mode,
wherein (a) through (c) are performed only if the neighboring block does not correspond to the directional intra-mode, and the third filter strength is greater than the first filter strength and the second filter strength.

9. The method of claim 8, wherein the boundary includes at least one of a horizontal boundary and a vertical boundary between the current block and the neighboring block.

10. The method of claim 9, wherein the first filter strength is “2”, the second filter strength is “1”, and the third filter strength is “4”.

11. A method of deciding a deblocking filter strength for performing a deblocking filtering with respect to a boundary between a current block coded by an intra-BL mode and a neighboring block, the method comprising:
(a) determining whether the current block and the neighboring block have coefficients;
(b) determining whether the current block and the neighboring block correspond to the intra-BL mode in which the current block and the neighboring block have a same base frame; and
(c) deciding the filter strength as a first filter strength if both a first condition and a second condition are satisfied, deciding the filter strength as a second filter strength if one of the first and second conditions is satisfied, and deciding the filter strength as a third filter strength if neither of the first and second conditions is satisfied,
wherein the first condition is that the current block and the neighboring block have the coefficients and the second condition is that the current block and the neighboring block do not correspond to the intra-BL mode in which the current block and the neighboring block have the same base frame,
wherein the first filter strength is greater than the second filter strength, and the second filter strength is greater than the third filter strength.

12. The method of claim 10, further comprising:
determining whether the neighboring block corresponds to a directional intra-mode; and
deciding the filter strength as a fourth filter strength if it is determined that the neighboring block corresponds to the directional intra-mode,
wherein (a) through (c) are performed only if the neighboring block does not correspond to the directional intra-mode, and the fourth filter strength is greater than the first filter strength.

13. The method of claim 12, wherein the boundary includes at least one of a horizontal boundary and a vertical boundary between the current block and the neighboring block.

14. The method of claim 13, wherein the first filter strength is “2”, the second filter strength is “1”, the third filter strength is “0”, and the fourth filter strength is “4”.

15. A video encoding method based on a multilayer using a deblocking filtering, the video encoding method comprising:
(a) encoding a video frame;
(b) decoding the encoded video frame;
(c) deciding a deblocking filter strength to be applied with respect to a boundary between a current block and a neighboring block that are included in the decoded video frame; and
(d) performing the deblocking filtering with respect to the boundary according to the decided deblocking filter strength,
wherein (c) is performed considering whether the current block corresponds to an intra-BL mode and whether the current block or the neighboring block has coefficients.

16. The video encoding method of claim 15, wherein (c) is performed based on whether the current block and the neighboring block correspond to an intra-BL mode in which the current block and the neighboring block have a same base frame.

17. The video encoding method of claim 16, wherein (c) is performed based on whether the neighboring block corresponds to a directional intra-mode.

16. A video decoding method based on a multilayer using a deblocking filtering, the video decoding comprising:
(a) restoring a video frame from a bitstream;
(b) deciding a deblocking filter strength to be applied with respect to a boundary between a current block and its neighboring block that are included in the restored video frame; and
(c) performing the deblocking filtering with respect to the boundary according to the decided deblocking filter strength,
wherein (b) is performed based on whether the current block corresponds to an intra-BL mode and whether the current block or the neighboring block has coefficients.

19. The video decoding method of claim 18, wherein (b) is performed based on whether the current block and the neighboring block correspond to an intra-BL mode in which the current block and the neighboring block have a same base frame.

20. The video decoding method of claim 19, wherein (b) is performed based on whether the neighboring block corresponds to a directional intra-mode.

21. A video encoder based on a multilayer using a deblocking filtering, the video encoder comprising:
a first unit which encodes a video frame;
a second unit which decodes the encoded video frame;
a third unit which decides a deblocking filter strength to be applied with respect to a boundary between a current block and a neighboring block that are included in the decoded video frame; and
a fourth unit which performs the deblocking filtering with respect to the boundary according to the decided deblocking filter strength,
wherein the third unit decides the filter strength based on whether the current block corresponds to an intra-BL mode and whether the current block or the neighboring block has coefficients.

22. A video decoder based on a multilayer using deblocking filtering, the video decoder comprising:
a first unit which restores a video frame from a bitstream;
a second unit which decides a deblocking filter strength to be applied with respect to a boundary between a current block and a neighboring block that are included in the restored video frame; and
a third unit which performs the deblocking filtering with respect to the boundary according to the decided deblocking filter strength,
wherein the second unit decides the filter strength based on whether the current block corresponds to an intra-BL mode and whether the current block or the neighboring block has coefficients.
